(19) United States
(12) Patent Application Publication
(10) Pub. No.: US 2018/0300621 A1
(43) Pub. Date: Oct. 18, 2018

(54) LEARNING DEPENDENCIES OF PERFORMANCE METRICS USING RECURRENT NEURAL NETWORKS

(71) Applicant: International Business Machines Corporation, Armonk, NY (US)

(72) Inventors: Syed Y. Shah, Ossining, NY (US); Zengwen Yuan, Los Angeles, CA (US); Petros Zerfos, New York, NY (US)

(73) Assignee: International Business Machines Corporation, Armonk, NY (US)

(21) Appl. No.: 15/486,584

(22) Filed: Apr. 13, 2017

(51) Int. Cl. G06N 3/08; G06N 5/02; G06N 7/00

(52) U.S. Cl. CPC G06N 3/08; G06N 7/005; G06N 5/02

(57) ABSTRACT

A processor receives time series data and a function describing a type of dependency that is desired to be determined from the time series data. A probe matrix is determined based upon the function. A weight matrix including a plurality of weights is determined, and a weighted probe matrix is determined based upon the probe matrix and the weighted matrix. The time series data and the weighted probe matrix is input into a neural network, and the neural network is trained using the time series data and the weighted probe matrix to converge the plurality of weights in the weight matrix. The converged weight matrix is extracted from an output of the neural network, and dependencies in the time series data are determined based upon the converged weight matrix.

### TECHNICAL FIELD

The present invention relates generally to a method, system, and computer program product for processing performance metrics using recurrent neural networks. More particularly, the present invention relates to a method, system, and computer program product for learning dependencies of performance metrics using recurrent neural networks.

### BACKGROUND

An Artificial Neural Network (ANN)—also referred to simply as a neural network—is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex but on much smaller scales. A large ANN might have hundreds or thousands of processor units, whereas a mammalian brain has billions of neurons with a corresponding increase in magnitude of their overall interaction and emergent behavior. A feedforward neural network is an artificial neural network where connections between the units do not form a cycle.

In machine learning, a convolutional neural network (CNN) is a type of feed-forward artificial neural network in which the connectivity pattern between the nodes (neurons) is inspired by the organization of the animal visual cortex, whose individual neurons are arranged to respond to overlapping regions tiling a visual field. Convolutional networks mimic biological processes and are configured as variations of multilayer perceptrons designed to use minimal amounts of preprocessing while processing data, such as digital images.

Convolutional neural networks (CNN) are networks with overlapping “reception fields” performing convolution tasks. A CNN is particularly efficient in recognizing image features, such as by differentiating pixels or pixel regions in a digital image from other pixels or pixel regions in the digital image. Generally, a CNN is designed to recognize images or parts of an image, such as detecting the edges of an object recognized on the image. Computer vision is a field of endeavor where CNNs are commonly used.

Recurrent neural networks (RNN) are networks with recurrent connections (going in the opposite direction that the “normal” signal flow) which form cycles in the network's topology. In RNNs, a neuron feeds back information to itself in addition to passing it to the next neuron in the RNN. Computations derived from earlier input are fed back into the network, which gives an RNN something similar to a short-term memory. Feedback networks, such as RNNs, are dynamic; their ‘state’ is changing continuously until they reach an equilibrium point. For this reason, RNNs are particularly suited for detecting relationships across time in a given set of data. Long-Short Term Memory (LSTM) and Gated Recurrent Units (GRU) are types of RNNs that include a state preserving mechanism through built-in memory cells. These types of RNNs are particular suited for multi-variate time series data analysis and forecasting, handwriting recognition, natural language processing and task synthesis.

A deep neural network (DNN) is an artificial neural network (ANN) with multiple hidden layers of units between the input and output layers. Similar to shallow ANNs, DNNs can model complex non-linear relationships. DNN architectures, e.g., for object detection and parsing, generate compositional models where the object is expressed as a layered composition of image primitives. The extra layers enable composition of features from lower layers, giving the potential of modeling complex data with fewer units than a similarly performing shallow network. DNNs are typically designed as feedforward networks.

An important mathematical operation during neural network processing is performing a convolution between matrices. However, conventional convolution operations can require significant memory usage in computer systems or devices having memory size constraints, such as cache or prefetch memory found in central processing units (CPUs)/graphics processing unit (GPUs), or in devices with limited memory, such as mobile devices or Internet-of-Things (IoT) devices.

### SUMMARY

The illustrative embodiments provide a method, system, and computer program product. An embodiment of a method includes receiving, by a processor, time series data, and receiving a function. In the embodiment, the function describes a type of dependency that is desired to be determined from the time series data. The embodiment further includes determining, using the processor and a memory, a probe matrix based upon the function, and determining a weight matrix including a plurality of weights. The embodiment further includes determining a weighted probe matrix based upon the probe matrix and the weighted matrix, and inputting the time series data and the weighted probe matrix into a neural network. The embodiment further includes training the neural network using the time series data and weighted probe matrix to converge the plurality of weights in the weight matrix. The embodiment further includes extracting the converged weight matrix from an output of the neural network, and determining dependencies in the time series data based upon the converged weight matrix.

In an embodiment, determining the dependencies in the time series data further includes determining average weights on neurons of the neural network to identify the most active neurons, and determining the most weighted rows of the probe matrix based upon the most active neurons.

In an embodiment, the function is defined to extract dependencies in the time series data. In another embodiment, the function is defined to extract data dependency among the time-series data. In still another embodiment, the function is defined to extract data lagged temporal dependency among the time series data.

In an embodiment, the time series data includes performance metric data. An embodiment further include monitoring at least one of an application and system to determine the performance metric data, wherein the performance metric data is associated with a measured performance of the at least one application and system.

In an embodiment, the performance metric data includes at least one of an application processor utilization, application received bandwidth utilization, application transmitted bandwidth utilization, database processor utilization, database memory utilization, database transmitted bandwidth utilization, database received bandwidth utilization, database read latency, and database write latency.

In an embodiment, the neural network includes a recurrent neural network (RNN).

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts an example of a conventional Long-Short Term Memory (LSTM) unit of a recurrent neural network (RNN);

FIG. 4 depicts an example of a Long-Short Term Memory (LSTM) unit of a recurrent neural network (RNN) in accordance with an illustrative embodiment;

FIG. 5 depicts a block diagram of a neural network application according to an illustrative embodiment;

FIG. 6 depicts a block diagram of a neural network application according to another illustrative embodiment;

FIG. 7 depicts a block diagram of a neural network application according to another illustrative embodiment;

FIG. 8 depicts a block diagram of a neural network application according to another illustrative embodiment; and

FIG. 9 depicts a flowchart of an example process for processing performance metrics and discovering dependencies between the performance metrics according to an illustrative embodiment

### DETAILED DESCRIPTION

The illustrative embodiments described herein generally relate to learning dependencies of performance metrics operations using a neural network such as a recurrent neural network. It is often desirable to monitor performance metrics of a distributed application/system, such as central processing unit (CPU) utilization, network utilization, and disk input/output (IO) performance, during operation of the system. Knowledge of the performance metrics of a system may be useful for a variety of tasks including performance monitoring tasks, resource utilization management, and early outage warnings.

Performance metrics at an application level as well as an infrastructure level have inherent dependencies with one another. For example, in a particular situation, network utilization may spike before CPU utilization spikes. In another example, in a production system some monitored performance metrics may arrive before others. For example, network usage values may be made available before CPU usage values are sent by a monitoring system or crawler. Such dependencies may include both leading dependencies and lagged dependencies. It is difficult to determine the performance metrics that are the strongest performance indicators for system performance due to interdependency between one or more of a number of the performance metrics. Although various embodiments have been described with respect to determining dependencies within performance metrics data, it should be understood that other embodiments include determining dependencies of any form of multi-variate time series data such as financial data sets, stock prices, etc.

In one or more embodiments, one or more monitoring applications monitor a time series of performance metrics for an application/system. In one or more embodiments, a neural network application is an application that implements one or more neural networks such as an RNN. A neural network application inputs the time series of performance metrics and a probe matrix to a neural network, and the neural network discovers runtime dependencies, such as precedence relationships, among the performance metrics using the probe matrix. In one or more embodiments, the discovered dependencies are used to derive leading indicators of performance and uncover structure regarding the performance of a distributed application/system that is being monitored. Examples of monitoring metrics may include, but are not limited to, application CPU utilization, application received bandwidth utilization, application transmitted bandwidth utilization, database CPU usage, database memory usage, database transmitted bandwidth utilization, database received bandwidth utilization, database read latency, and database write latency.

In one or more embodiments, a neural network application utilizes a recurrent neural network (RNN) to process the performance metrics and discover dependencies between the performance metrics. In conventional use of a neural network, such as an RNN, the neural network is trained over input data. After the neural network converges, an output is extracted from the network. In accordance with one or more embodiments described herein, input data, such as performance metrics, to the RNN is manipulated by inputting a probe matrix to use the inherent learning mechanism of the RNN to additionally learn the dependencies in the input data.

In one or more embodiments, the neural network application generates a function g that describes a type of dependency that is desired to be learned from performance metric input data or other multi-variate time series data, e.g., time lags (regressive behavior), leading-indicator information, etc. In one particular embodiment, the function is a user defined function is generated to find leading indicator relationships and/or dependencies in the performance measurement data. In another particular embodiment, the user defined function is generated to find lagged value or temporal dependency of performance measurement data. In at least one embodiment, the neural network application generates the function in response to a user providing certain parameters of the dependencies that are of interest to the user, and the application generates the function based on the parameters.

In one or more embodiments, the neural network application generates a probe matrix D from the function g in which the probe matrix D includes values that are calculated using the function g. In particular embodiments, the application or a user provides time series data or a subset of the time series data to be analyzed to generate parameters that describe dependencies using the function g. Accordingly, in various embodiments the application uses the function g to generate additional parameters that describe dependencies. In particular embodiments, the application includes one or more different g functions each directed to a different type of desired dependency within the time series data such as lagged dependencies or leading indicator dependencies. In a particular embodiment, a user selects a desired g function and the application applies the g function to the subset of time series data. The application then inputs the results of the g function to the RNN.

In the particular embodiment, the application further constructs the probe matrix D from the results of the function g being applied to the time series data. In one or more embodiments, the neural network application generates a weighted probe matrix V.D using the probe matrix D and a weighting vector and/or matrix V in which the matrix entries of probe matrix D are weighted by corresponding entries in vector/matrix V. In one or more embodiments, the dimension of the weighting matrix V is dependent upon the dimension of the probe matrix D. In particular embodiments, the initial values of the weighting matrix V are generated using random number of other known techniques for initializing a weighting matrix.

In one or more embodiments, the neural network application constructs a neural network and inputs the performance metric data and weighted (or unweighted) probe matrix into the neural network. In particular embodiments, the neural network is an RNN. In one or more embodiments, the neural network is trained using the performance metric input and weighted probe matrix until the neural network converges such that an error determined by a function is minimized to an acceptable level. In particular embodiments, the neural network converges when the weights in V converge. In one or more embodiments, during training of the neural network the neural network will assign higher weight to values of vector/matrix V that are more important in producing a final output.

In one or more embodiments, upon convergence of the neural network, the neural network application extracts the matrix V from the neural network output and analyzes the matrix V to determine the desired relationships/dependencies in the performance measurement metrics. In particular embodiments, the values of matrix V are maintained internally for each layer in the neural network and the weighted probe matrix V.D is modified during processing of the time-series data by the neural network, and after processing of the time-series data the weighted probe matrix V.D is extracted for analysis. In particular embodiments, the matrix V is analyzed by calculating the average of the weights for a particular time series over each layers of the neural network, and using the average weights to determine the predominance of each input time series. In other embodiments, other methods of analysis can be applied to the weights to identify one or more predominant input time series within the time series data. Although various embodiments are described as using average weights to find active neurons, it should be understood that in other embodiments, other statistical analysis processes can be applied to neuron weights and weight matrices to find active neurons.

The illustrative embodiments are described with respect to certain types of matrices and matrix dimensions, arrays and array dimensions, performance measurement metrics, time series data, neural networks, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

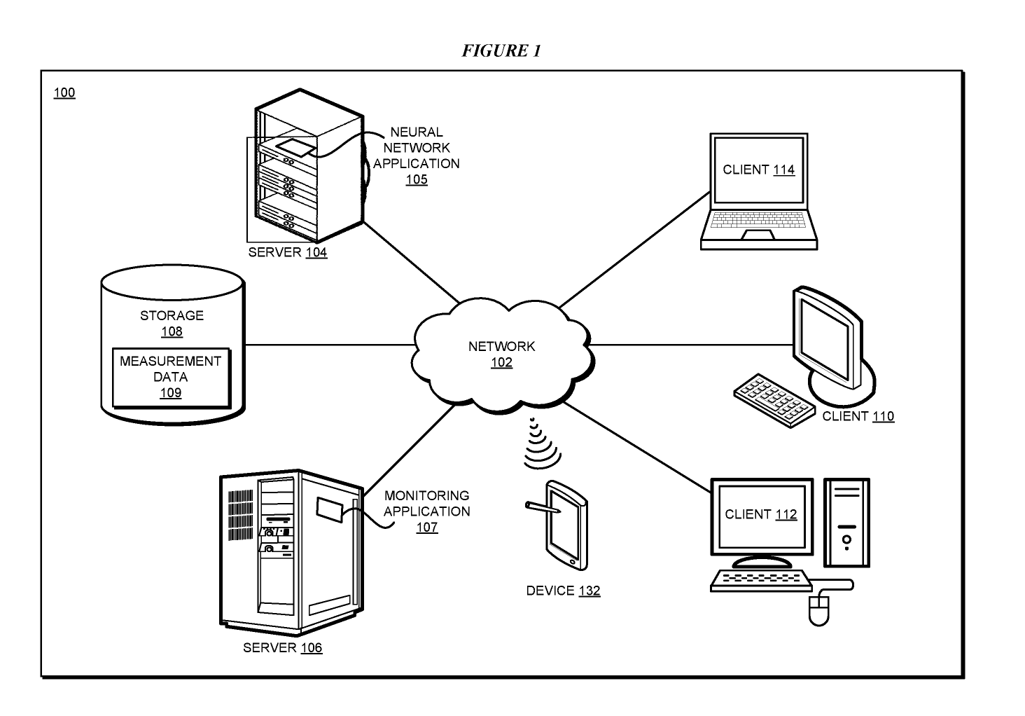

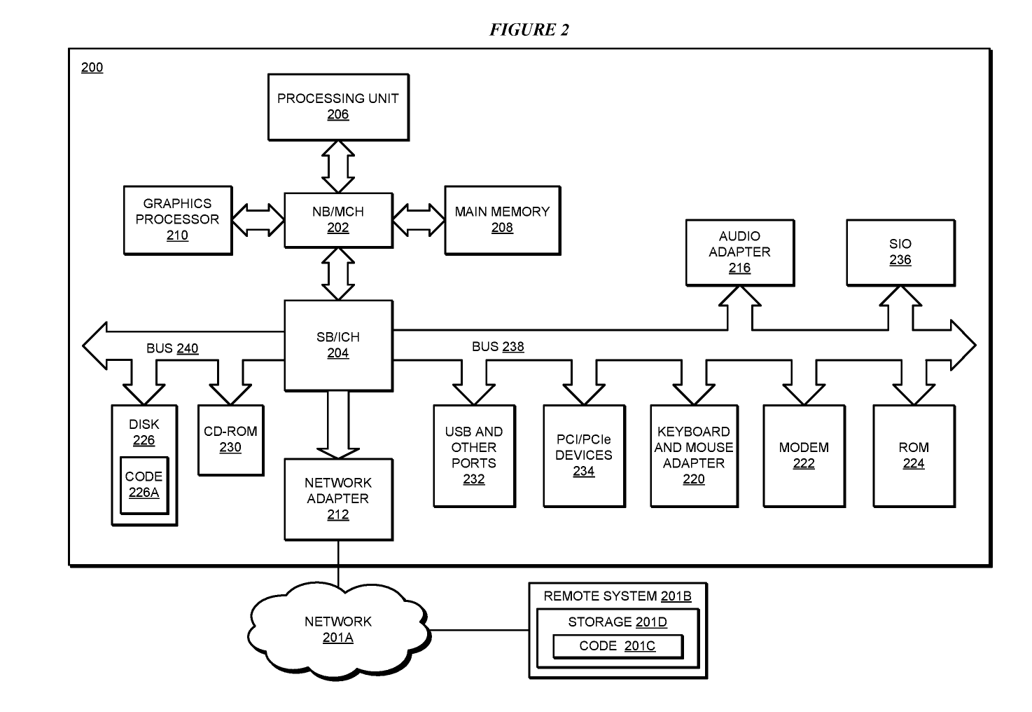

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. In one or more embodiments, storage 108 may be configured to store measurement data 109 including performance metric data associated with one or more applications and/or systems that is obtained from monitoring the applications and/or systems. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Neural network application 105 of server 104 implements an embodiment of a neural network configured to perform performance metrics processing operations, such as an RNN, as described herein. Monitoring application 107 of server 106 is configured to monitor performance metrics associated with server 106 or other devices within a system of data processing system 100.

Device 132 is an example of a device described herein. For example, device 132 may send a request to server 104 to perform one or more data processing tasks by neural network application 105 utilizing one or more performance metrics processing operations. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as applications 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. In another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

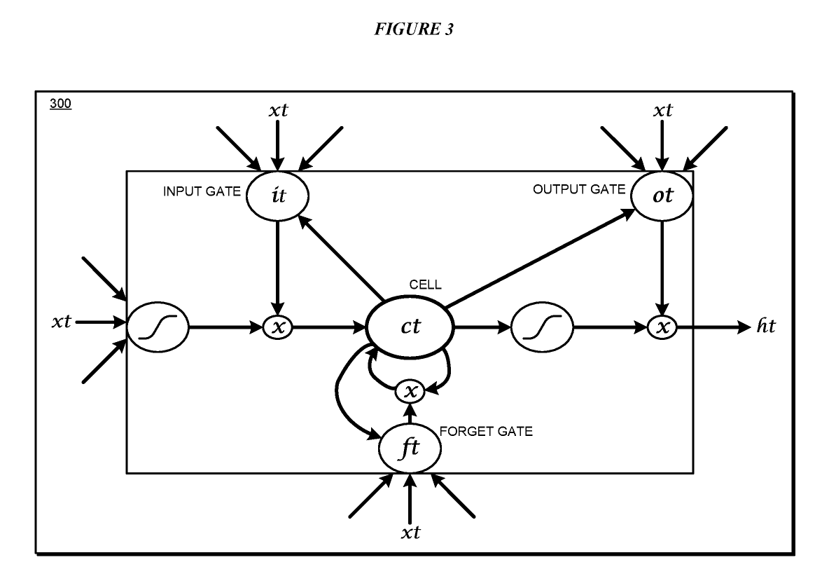

With respect to FIG. 3, this figure depicts an example of a conventional Long-Short Term Memory (LSTM) unit 300 of a recurrent neural network (RNN). It should be understood that an RNN is constructed from a plurality of LSTM units 300. The LSTM unit 300 includes an input gate iₜ, an output gate oₜ, a memory cell cₜ, a forget gate fₜ, multiplication operations X, and squashing functions f. Generally, the input gate iₜ controls the data flow into the memory cell cₜ, the forget gate fₜ controls the data flow out of the unit 300, and the output gate iₜ controls how the data is translated into output values. In the example of FIG. 3, a hidden state hₜ at a time step t is a function of an input xₜ at the same time step t. An input xₜ is provided to the input gate iₜ, forget gate fₜ, and output gate oₜ to produce the hidden state hₜ. The input xₜ and hidden state hₜ are each squashed by a squashing function f, such as a logistic sigmoid function or tanh function, to compress the output of the neuron. Unit 300 takes the output hₜ₋₁ of the last step, the input for the current step xₜ, the memory cell value of the last step cₜ₋₁, and a bias term bᵢ in order to update the neural network. The bias term bᵢ is chosen based upon the particular implementation of the neural network framework. Mathematically, the relationship between the input and output of the LSTM may be defined by the following equation:

iₜ=σ(Wₕ·hₜ₋₁+Wₓ·xₜ+bᵢ) (Equation 1)

in which Wₕ and Wₓ are each a weight matrix for weighting hₜ₋₁ and xₜ, respectively. The initial values of the weighted matrices may be determined according to a number of known techniques such as initializing the values of the weighted matrixes randomly.

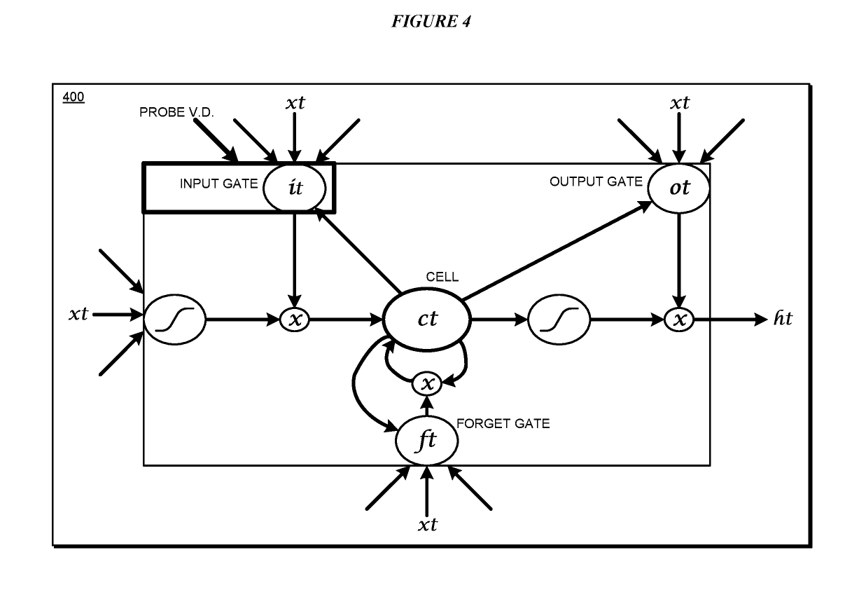

With respect to FIG. 4, this figure depicts an example of a Long-Short Term Memory (LSTM) unit of a recurrent neural network (RNN) in accordance with an illustrative embodiment. It should be understood that an RNN is constructed from a plurality of LSTM units 400. The LSTM unit 400 includes an input gate iₜ, an output gate oₜ, a memory cell cₜ, and a forget gate fₜ. In contrast to the conventional LSTM unit 300 of FIG. 3, in the embodiment of the LSTM unit 400 of FIG. 4, a weighted probe matrix V.D is computed using a probe matrix D and a weight matrix V as further described herein. In particular embodiments, values of the probe matrix D are computed from a user-defined function g that defines a type of dependency that is desired to be learned from performance metric input data. In particular embodiments, a type of dependency defined by the user-defined function g includes time lag information or leading indicator information associated with one or more performance metrics of the performance metric input data. In particular embodiments, weight matrix V is a weight matrix containing real numbers.

In the embodiment of FIG. 4, an input xₜ containing performance metric data and the weighted probe matrix V.D are both provided to the input gate iₜ. The input xₜ and hidden state hₜ are each squashed by a function, such as a logistic sigmoid function or tanh function. Unit 400 takes the output hₜ₋₁ of the last step, the input for the current step xₜ and the weighted probe matrix V.D, the memory cell value of the last step cₜ₋₁, and a bias term b₁ in order to update the neural network. Mathematically, the relationship between the input and output of the LSTM may be defined by the following equation:

iₜ=σ(Wₕ·hₜ₋₁+V.D.+Wₓ·xₜ+bᵢ) (Equation 2)

in which Wₕ and Wₓ are each a weight matrix for weighting hₜ₋₁ and xₜ, respectively. Accordingly, the RNN is trained using both the performance metric input data and the weighted probe matrix V.D until the neural network converges. During convergence of the neural network, the neural network will assign higher weight values to values in the weight matrix that are associated with performance metrics having a greater influence in producing a final output after convergence.

In an example operation of an illustrative embodiment, it is desired to find leading indicator relationships and/or dependencies in the performance metric data obtained as a result of monitoring one or more applications and/or systems in the data processing environment 100. In an embodiment, an example user-defined function for identifying leading indicator dependencies is determined as:

g(a, b, c)=[aₜbₜ, cₜ] (Equation 3)

in which aₜ, bₜ, and cₜ are current values of performance metrics whose dependencies are desired to be learned.

An example weighted probe matrix for finding leading indicator dependencies is of the form:

$$V \cdot D = [ \begin{matrix}w 1 \\ ⋮ \\ wi\end{matrix} ] \cdot [ \begin{matrix}app - cpu & app - rx & app - tx & db - cpu & …\end{matrix} ] \qquad ( Equation 4 )$$

in which app-cpu is a monitored CPU utilization by an application, app-rx is received bandwidth utilization by the application, app-tx is transmitted bandwidth of the application, and db-cpu is database utilization.

A generalized weighted probe matrix for finding leading indicator dependencies is of the form:

$$V \cdot D = [ \begin{matrix}w 1 \\ ⋮ \\ wi\end{matrix} ] \cdot [ {a}^{t} {b}^{t} {c}^{t} ] \qquad ( Equation 5 )$$

The weighted probe matrix and the performance metric data is input into the RNN, and the RNN iterates until convergence is reached. Upon convergence of the RNN, the neural network application extracts the weight matrix V from the output data and analyzes the weight matrix V to determine the leading indicator dependencies in the performance metric data. In an example operation, it is desired to determine the performance metric dependencies having the greatest influence on average temperature of a system. In a particular embodiment, the neural network application analyzes the converged weight matrix V by determining average weights of all neurons in the neural network to determine the most active neurons and the corresponding most weighted rows in probe matrix D. In one or more embodiments, the neural network application calculates an average of the weights of weight matrix V for the layers of the neural network since a weight matrix V exists for each layer having a separate weight for each input times series data set in matrix D. The average weights are indicative of the importance of each input time series in the time series data. In the particular embodiment, upon convergence of the network, the weight matrix V is used to determine that the performance metrics of app-tx, app-rx, and app-cpu have the greatest influence upon the database received bandwidth utilization (db-rx) of the system. In a particular embodiment, the matrix V is displayed as a heatmap visualization in which “high temperatures” show performance metrics app-tx, app-rx, and app-cpu as the strongest predictors of the input performance metrics for the target performance metric db-rx.

In another example operation of an illustrative embodiment, it is desired to find lagged value/temporal dependencies in the performance metric data obtained as a result of monitoring one or more applications and/or systems in the data processing environment 100. In an embodiment, an example user-defined function in which a is the input for which lags or temporal dependency is desired to be investigated is determined as:

g(a)=[aₜ₋₁aₜ₋₂, . . . , aₜ₋ₕ] (Equation 6)

in which aₜ is a current value of the performance metric, and aₜ₋₁, aₜ₋₂ to aₜ₋ₕ are h past values of the performance metric.

An example weighted probe matrix for finding lagged value dependencies is of the form:

$$V \cdot D = [ \begin{matrix}w 1 \\ ⋮ \\ wi\end{matrix} ] \cdot [ \begin{matrix}app - {rx}_{t - 1} & app - {rx}_{t - 2} & … & app - {rx}_{t - h}\end{matrix} ] \qquad ( Equation 7 )$$

in which app-rx is a performance metric of monitored application bandwidth utilization.

A generalized weighted probe matrix for finding leading indicator dependencies is of the form:

$$V \cdot D = [ \begin{matrix}w 1 \\ ⋮ \\ wi\end{matrix} ] \cdot [ {a}^{t - 1} {a}^{t - 2} … {a}^{t - 2} ] \qquad ( Equation 8 )$$

The weighted probe matrix and the performance metric data is input into the RNN, and the RNN iterates until convergence is reached. Upon convergence of the RNN, the neural network application extracts the weight matrix V from the output data and analyzes the weight matrix V to determine the lagged value/temporal dependencies in the performance metric data. In an example operation, it is desired to determine the performance metric dependencies having the greatest influence on average temperature of a system. Upon convergence of the network, the weight matrix V is used to determine that the lagged value of app-rx having the greatest prediction of application received bandwidth utilization (app-rx) of the system if the value at time t is not yet available. In a particular embodiment, the matrix V is displayed as a heatmap visualization in which “high temperatures” show performance metrics app-rx over various lagged values and app-rxₜ₋₁ is shown as the strongest predictors of app-rx if the value at time t is not yet available.

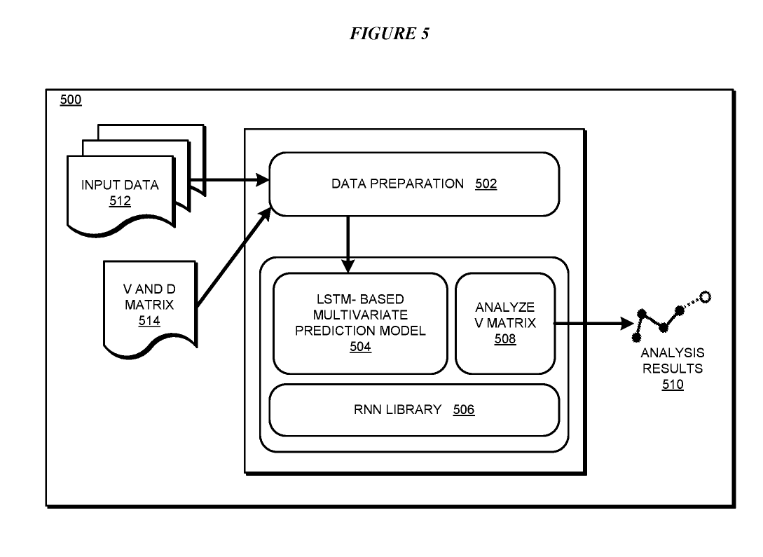

With reference to FIG. 5, this figure depicts a block diagram of a neural network application 500 according to an illustrative embodiment. In particular embodiments, the neural network application 500 is neural network application 105 of FIG. 1. The neural network application 500 includes a data preparation component 502, a LSTM-based multivariate prediction model 504, an RNN library 506, and an analysis component 508. In the embodiment illustrated in FIG. 5, data preparation component 502 of neural network application 500 receives input data including monitored performance metric data. In the embodiment, data preparation component 502 further receives both weight matrix V and probe matrix D as separate matrices.

In the embodiment, data preparation component 502 computes the weighted probe matrix V.D from the weight matrix V and probe matrix D. In the embodiment, data preparation component 502 provides the performance metrics and weighted probe matrix V.D as inputs to LSTM-based multivariate prediction model 504. LSTM-based multivariate prediction model 504 uses multiple variables to predict an output using an LSTM-based model. In the embodiment, LSTM-based multivariate prediction model 506 utilizes software functions defined in RNN library 506 to implement a neural network such as an RNN. In the embodiment, the LSTM-based multivariate prediction model 506 updates weight matrix V in an iterative manner until the neural network converges. Upon convergence of the neural network, LSTM-based multivariate prediction model 506 provides the converged matrix V as an output to analysis component 508. In the embodiment, analysis component 508 analyzes V matrix and outputs analysis results 510.

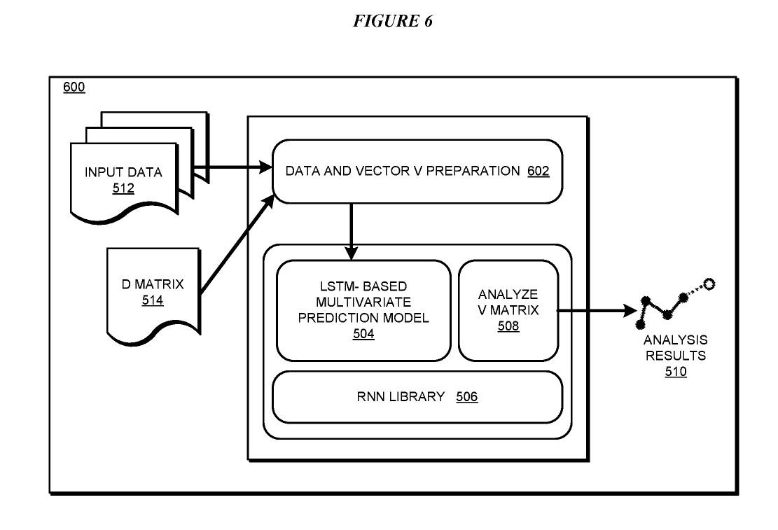

With reference to FIG. 6, this figure depicts a block diagram of a neural network application 600 according to an illustrative embodiment. In particular embodiments, the neural network application 600 is neural network application 105 of FIG. 1. The neural network application 600 includes a data and weighting vector V preparation component 602, LSTM-based multivariate prediction model 504, RNN library 506, and analysis component 508. In the embodiment illustrated in FIG. 6, data and weighting vector V preparation component 602 of neural network application 600 receives input data including monitored performance metric data. In the embodiment, data and weighting vector V preparation component 602 further receives probe matrix D and computes the initial weight matrix V.

In the embodiment, data and weighting vector V preparation component 602 computes the weighted probe matrix V.D from the initial weight matrix V and probe matrix D. In the embodiment, data and weighting vector V preparation component 602 provides the performance metrics and weighted probe matrix V.D as inputs to LSTM-based multivariate prediction model 504. In the embodiment, LSTM-based multivariate prediction model 506 utilizes software functions defined in RNN library 506 to implement a neural network such as an RNN. In the embodiment, the LSTM-based multivariate prediction model 506 updates weight matrix V in an iterative manner until the neural network converges. Upon convergence of the neural network, LSTM-based multivariate prediction model 506 provides the converged matrix V as an output to analysis component 508. In the embodiment, analysis component 508 analyzes V matrix and outputs analysis results 510.

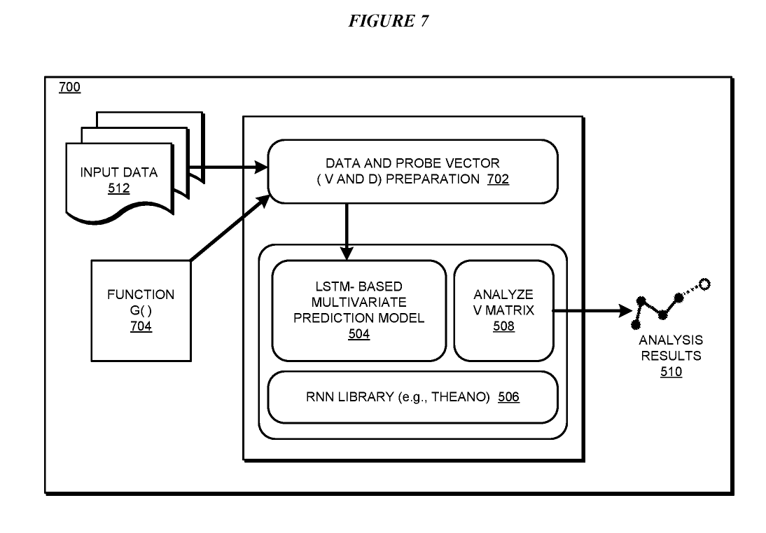

With reference to FIG. 7, this figure depicts a block diagram of a neural network application 700 according to an illustrative embodiment. In particular embodiments, the neural network application 700 is neural network application 105 of FIG. 1. The neural network application 700 includes a data and probe vector V and D preparation component 702, LSTM-based multivariate prediction model 504, RNN library 506, and analysis component 508. In the embodiment illustrated in FIG. 7, data and probe vector V and D preparation component 702 of neural network application 700 receives input data including monitored performance metric data but does not receive either the probe matrix D and weight matrix V. Instead, a user-defined function g( ) 704 is provided to data and probe vector V and D preparation component 702, and data and probe vector V and D preparation component 702 computes both probe matrix D and weight matrix V from the user-defined function g( ) 704.

In the embodiment, data and probe vector V and D preparation component 702 computes the weighted probe matrix V.D from the weight matrix V and probe matrix D. In the embodiment, data and weighting vector V preparation component 602 provides the performance metrics and weighted probe matrix V.D as inputs to LSTM-based multivariate prediction model 504. In the embodiment, LSTM-based multivariate prediction model 506 utilizes software functions defined in RNN library 506 to implement a neural network such as an RNN. In the embodiment, the LSTM-based multivariate prediction model 506 updates weight matrix V in an iterative manner until the neural network converges. Upon convergence of the neural network, LSTM-based multivariate prediction model 506 provides the converged matrix V as an output to analysis component 508. In the embodiment, analysis component 508 analyzes V matrix and outputs analysis results 510.

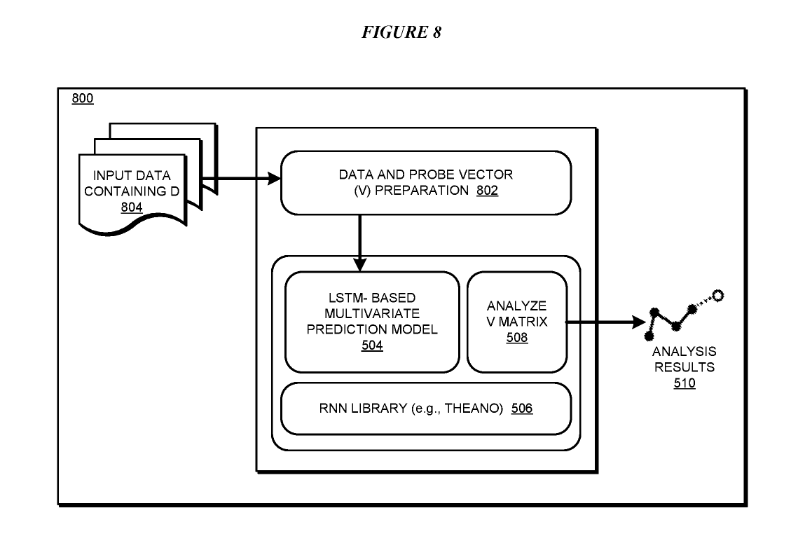

With reference to FIG. 8, this figure depicts a block diagram of a neural network application 800 according to an illustrative embodiment. In particular embodiments, the neural network application 800 is neural network application 105 of FIG. 1. The neural network application 800 includes a data and probe vector V preparation component 802, LSTM-based multivariate prediction model 504, RNN library 506, and analysis component 508. In the embodiment illustrated in FIG. 8, data and probe vector V preparation component 802 of neural network application 800 receives input data including monitored performance metric data concatenated with the probe matrix D. Data and probe vector V preparation component 802 computes weight matrix V.

In the embodiment, data and probe vector V preparation component 802 computes the weighted probe matrix V.D from the weight matrix V and probe matrix D. In the embodiment, data and probe vector V preparation component 802 provides the performance metrics and weighted probe matrix V.D as inputs to LSTM-based multivariate prediction model 504. In the embodiment, LSTM-based multivariate prediction model 506 utilizes software functions defined in RNN library 506 to implement a neural network such as an RNN. In the embodiment, the LSTM-based multivariate prediction model 506 updates weight matrix V in an iterative manner until the neural network converges. Upon convergence of the neural network, LSTM-based multivariate prediction model 506 provides the converged matrix V as an output to analysis component 508. In the embodiment, analysis component 508 analyzes V matrix and outputs analysis results 510.

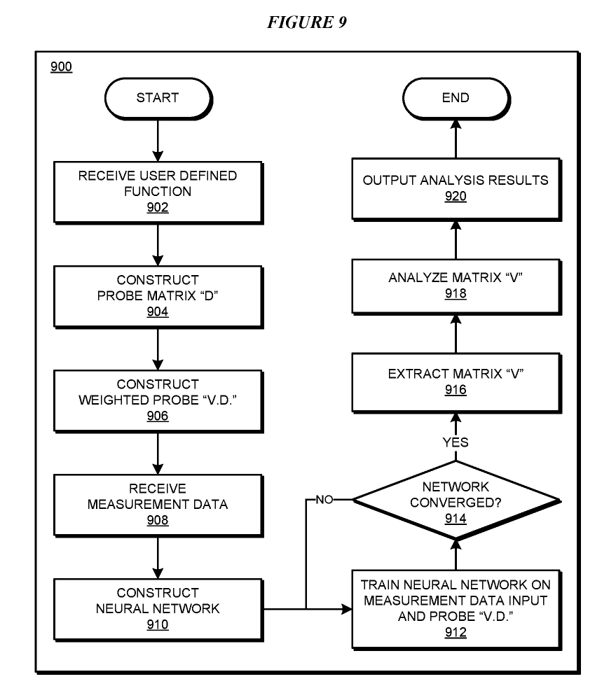

With reference to FIG. 9, this figure depicts a flowchart of an example process 900 for processing performance metrics and discovering dependencies between the performance metrics according to an illustrative embodiment. In block 902, neural network application 105 receives a user-defined or user-specified function that describes a type of dependency that is desired to be learned from performance metric input data. In block 904, neural network application 105 constructs a probe matrix D from the user-defined function. In block 906, neural network application 105 constructs a weighted probe vector V.D from the probe matrix D and a weight matrix V. In particular embodiments, neural network application 105 automatically generates weighted matrix V.

In block 908, neural network application 105 receives measurement data including performance metrics associated with one or more monitored applications or devices. In block 910, neural network application 105 constructs a neural network. In a particular embodiment, the neural network is a RNN. In block 912, neural network application 105 trains the neural network on the measurement data input and the probe matrix V.D. In 914, neural network application 105 determines whether the neural network has converges. If the neural network has not converged, the process returns to block 912. If the neural network has converged, the process continues to block 916.

In block 916, neural network application 105 extracts the converged weighted matrix V from the output of the neural network. In block 918, neural network application 105 analyzes the converged weighted matrix V to determine analysis results. In one or more embodiments, the analysis results include dependencies in the performance metric data. In block 920, neural network application 105 outputs the analysis results including the dependencies in the performance metric data. The process 900 then ends.

Although various embodiments are described with respect to performing operations within a neural network, it should be understood that the principles described herein may be applied to any suitable prediction networks performed by a computer system or other electronic device.

Thus, a computer implemented method, system or apparatus, and computer program product are provided in the illustrative embodiments for operations with a neural network and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
receiving, by a processor, time series data;
receiving a function, the function describing a type of dependency that is desired to be determined from the time series data;
determining, using the processor and a memory, a probe matrix based upon the function;
determining a weight matrix including a plurality of weights;
determining a weighted probe matrix based upon the probe matrix and the weighted matrix;
inputting the time series data and the weighted probe matrix into a neural network;
training the neural network using the time series data and weighted probe matrix to converge the plurality of weights in the weight matrix;
extracting the converged weight matrix from an output of the neural network; and
determining dependencies in the time series data based upon the converged weight matrix.

2. The method of claim 1, wherein determining the dependencies in the time series data further comprises:
determining average weights on neurons of the neural network to identify the most active neurons; and
determining the most weighted rows of the probe matrix based upon the most active neurons.

3. The method of claim 1, wherein the function is defined to extract dependencies in the time series data.

4. The method of claim 1, wherein the function is defined to extract data dependency among the time-series data.

5. The method of claim 1, wherein the function is defined to extract data lagged temporal dependency among the time series data.

6. The method of claim 1, wherein the time series data includes performance metric data.

7. The method of claim 6, further comprising:
monitoring at least one of an application and system to determine the performance metric data, wherein the performance metric data is associated with a measured performance of the at least one application and system.

8. The method of claim 7, wherein the performance metric data includes at least one of an application processor utilization, application received bandwidth utilization, application transmitted bandwidth utilization, database processor utilization, database memory utilization, database transmitted bandwidth utilization, database received bandwidth utilization, database read latency, and database write latency.

9. The method of claim 1, wherein the neural network includes a recurrent neural network (RNN).

10. A computer usable program product comprising one or more computer-readable storage devices, and program instructions stored on at least one of the one or more storage devices, the stored program instructions comprising:
program instructions to receive, by a processor, time series data;
program instructions to receive a function, the function describing a type of dependency that is desired to be determined from the time series data;
program instructions to determine, using the processor and a memory, a probe matrix based upon the function;
determining a weight matrix including a plurality of weights;
program instructions to determine a weighted probe matrix based upon the probe matrix and the weighted matrix;
program instructions to input the time series data and the weighted probe matrix into a neural network;
program instructions to train the neural network using the time series data and weighted probe matrix to converge the plurality of weights in the weight matrix;
program instructions to extract the converged weight matrix from an output of the neural network; and
program instructions to determine dependencies in the time series data based upon the converged weight matrix.

11. The computer usable program product of claim 10, wherein the program instructions to determine the dependencies in the time series data further comprises:
program instructions to determine average weights on neurons of the neural network to identify the most active neurons; and
program instructions to determine the most weighted rows of the probe matrix based upon the most active neurons.

12. The computer usable program product of claim 10, wherein the function is defined to extract dependencies in the time series data.

13. The computer usable program product of claim 10, wherein the function is defined to extract data dependency among the time-series data.

14. The computer usable program product of claim 10, wherein the function is defined to extract data lagged temporal dependency among the time series data.

15. The computer usable program product of claim 10, wherein the time series data includes performance metric data.

16. The computer usable program product of claim 15, the stored program instructions further comprising:
program instructions to monitoring at least one of an application and system to determine the performance metric data, wherein the performance metric data is associated with a measured performance of the at least one application and system.

17. The computer usable program product of claim 10, wherein the computer usable code is stored in a computer readable storage device in a data processing system, and wherein the computer usable code is transferred over a network from a remote data processing system.

18. The computer usable program product of claim 10, wherein the computer usable code is stored in a computer readable storage device in a server data processing system, and wherein the computer usable code is downloaded over a network to a remote data processing system for use in a computer readable storage device associated with the remote data processing system.

19. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to receive, by a processor, time series data;
program instructions to receive a function, the function describing a type of dependency that is desired to be determined from the time series data;
program instructions to determine, using the processor and a memory, a probe matrix based upon the function;
determining a weight matrix including a plurality of weights;
program instructions to determine a weighted probe matrix based upon the probe matrix and the weighted matrix;
program instructions to input the time series data and the weighted probe matrix into a neural network;
program instructions to train the neural network using the time series data and weighted probe matrix to converge the plurality of weights in the weight matrix;
program instructions to extract the converged weight matrix from an output of the neural network; and
program instructions to determine dependencies in the time series data based upon the converged weight matrix.

20. The computer system of claim 19, wherein the program instructions to determine the dependencies in the time series data further comprises:
program instructions to determine average weights on neurons of the neural network to identify the most active neurons; and
program instructions to determine the most weighted rows of the probe matrix based upon the most active neurons.
